(19) United States
(12) Patent Application Publication
(10) Pub. No.: US 2007/0087732 A1
(43) Pub. Date: Apr. 19, 2007

(54) WIRELESS ELECTRONIC COUPON DELIVERY SYSTEM FOR USE BY MOBILE COMMUNICATION DEVICES

(75) Inventor: Shao Yuan Hsueh, Naperville, IL (US)

Correspondence Address: MICHAEL P. MAZZA, LLC, 686 CRESCENT BLVD., GLEN ELYN, IL, 60137, US

(73) Assignee: LeapFrog Technologies, Inc.

(21) Appl. No.: 11/557,276

(22) Filed: Nov. 7, 2006

Related U.S. Application Data
(63) Continuation of application No. 11/065,723, filed on Feb. 25, 2005.

(51) Int. Cl. H04Q 7/22

(52) U.S. Cl. 455/414.4; 370/352

(57) ABSTRACT

A wireless network and a process for delivering electronic coupons over the wireless network. Targeted coupons based on profile information submitted by a wireless network user may be transmitted to and then selected by the user. Information enabling a store to clear the coupons at checkout may be sent over the wireless network to a user's PDA or cell phone, for example.

### BACKGROUND OF THE INVENTION

The present invention relates to the field of electronic coupons. More particularly, the invention is directed to the use of electronic coupons over a wireless network.

The delivery of electronic discount coupons is known. Examples of companies that operate in this arena include Coolsavings (www.coolsavings.com), E-centives (www.ecentives.com) and Cataline Marketing International, Inc. (www.catalina-marketing.com). Each holds various patents in this field (e.g., U.S. Pat. Nos. 5,761,648; 6,321,208; and U.S. Pat. No. 6,584,448). These companies and others provide the capability of targeting and delivering online print-at-home coupons, or coupons that may be printed in-store, to motivate in-store sales.

It is also known to install or associate GPS tracking systems with cell phones. It has been suggested that using a GPS system to pinpoint a cell phone's location, coupons may then be sent to the phone. At the present time, this technology is relatively expensive.

The emergence of wireless fidelity (“Wi-Fi”) systems located at what are commonly called wireless hotspots has increased the mobility of wireless users and allowed mobile users to access network resources without requiring a physical connection to a large, expensive network. Many of these wireless hotspots have appeared in common areas such as coffee shops and libraries, and allow users with wireless communication equipment to communicate with local area networks and wide area networks as they move about.

It would be advantageous to disseminate electronic coupons in a wireless fashion. Obtaining wireless access at a wireless hotspot currently only requires user registration within the wireless network hotspot system, and that the wireless user have a device with a wireless card having a MAC address, which then allows the assignation of a dynamic IP address. However, known electronic coupon delivery systems generally require users to provide profile information, such as name, address and other personal information, which may then be used to target specific incentives or coupons. It would be desirable to allow consumers with wireless access to easily and painlessly participate in an electronic couponing system without having to divulge profile information.

### SUMMARY OF THE INVENTION

The present invention overcomes disadvantages of prior electronic coupon delivery systems and methods, while providing new advantages not previously obtainable with such systems and methods

In one preferred embodiment of the present invention, a process for delivering electronic coupons over a wireless network is provided. A wireless network enables user registration, during which the user provides profile information, such as user name and address, etc., to an administrator of the wireless network, for example. Once the registered user logs in to the wireless network, such as at a WiFi hotspot location, the wireless network may then associate the user with his/her profile information submitted during registration, for example, enabling the wireless network to locate the user within the wireless network using the access point's unique MAC address, for example. At least a portion of the profile information may now be used to identify targeted or personalized electronic coupons for the user, and those targeted electronic coupons may then be transmitted to the user over the wireless network. The user may then select one or more of the targeted electronic coupons, and may transmit this selection over the wireless network to a dedicated server, for example, which server may then transmit a request to the user to input a code,such as a mobile telephone number or an access code for a PDA, associated with the mobile communication device then being used by the user. Upon receipt of this code, the server within the wireless network, for example, may then transmit information associated with the selected electronic coupons to the mobile communication device associated with the inputted code. Such information, such as a unique coupon code and/or information summarizing the coupon and the goods or services to which it relates, is preferably that sufficient to enable a store to clear the selected coupon(s) during an in-store checkout procedure, for example.

A wireless network system enabling the delivery of electronic coupons also forms a preferred embodiment of the present invention. In this embodiment, one or more servers, as well as other associated hardware, may be provided in communication with user-accessible computers enabling user registration. The user-accessible computers may, but need not, be provided in a WiFi hotspot locale, for example. During registration at the hotspot locale, for example, users may be required to provide profile information entered into the computers, which may transmitted to the servers. Following user log-in to the wireless network after registration, the wireless network may associate a logged-in user with profile information for -hat user, enabling the wireless network to locate the user within the wireless network, such as by using the unique MAC address associated with the computer for that user. The one or more servers may now use at least a portion of the profile information submitted by that user to identify targeted electronic coupons for him/her, and transmit them to the computer of the associated user over the wireless network, enabling the user to select one or more of the targeted electronic coupons and to transmit this selection to the one or more servers over the wireless network. The one or more servers of the wireless network may now request the user to input a code, such as a mobile telephone number or access code for a PDA and then, upon receipt of the code, the servers may transmit information corresponding to the selected electronic coupons to a mobile communication device such as a telephone or PDA associated with that code input by the user.

### BRIEF DESCRIPTION OF THE DRAWINGS

The novel features which are characteristic of the invention are set forth in the appended claims. The invention itself, however, together with further objects and attendant advantages thereof, will be best understood by reference to the following description taken in connection with the accompanying drawings, in which:

FIG. 1 is a schematic view illustrating the “front end” of a preferred embodiment of the wireless electronic coupon system of the present invention; and

FIG. 2 is a schematic view illustrating the “back end” of a preferred embodiment of the wireless electronic coupon system of the present invention.

### DEFINITION OF CLAIM TERMS

The terms used in the claims of the patent as filed are intended to have their broadest meaning consistent with the requirements of law.

“Computer” means any device providing computing features, such as a PDA or interactive cell phone.

“PDA,” short for “personal digital assistant,” means a handheld device that provides computing and Internet-access features, and may also provide telephone, fax and networking features.

“Wireless network” means hardware such as servers, computers, network gears and related peripheral devices as well as associated software and firmware for linking such hardware within the network. Typical examples of such a network are a cellular phone network and a WiFi network.

### DETAILED DESCRIPTION OF THE PREFERRED EMBODIMENTS

Set forth below is a description of what are believed to be the preferred embodiments and/or best examples of the invention claimed. Future and present alternatives and modifications to this preferred embodiment are contemplated. Any alternatives or modifications which make insubstantial changes in function, in purpose, in structure, or in result are intended to be covered by the claims of this patent.

To summarize a preferred embodiment of the process of the present invention, a wireless LAN (local area network) user, such as a user on a personal computer, notebook or PDA, may log on to a wireless hotspot location, and access a wireless electronic coupon delivery system (WECDS) provided according to the present invention. The WECDS server receives the user's dynamically-assigned IP address, and his/her cellphone number, and transmits coupons to the user. The coupon identification numbers specific to these coupons may also be transmitted over the WECDS system to the user's cellphone using a text messaging system such as SMS; these coupon numbers may be stored on the cellphone, for in-store access by the user.

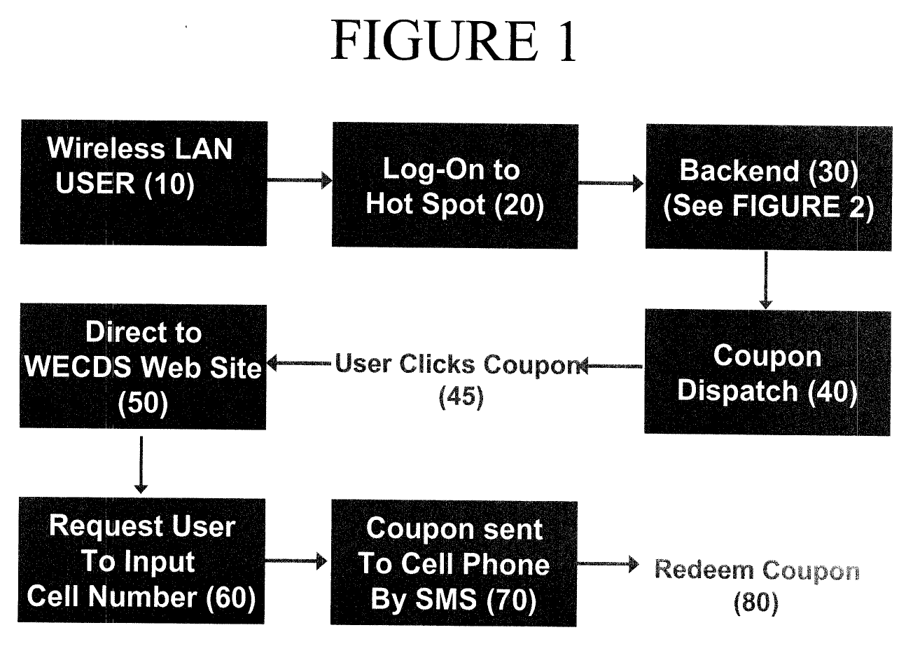

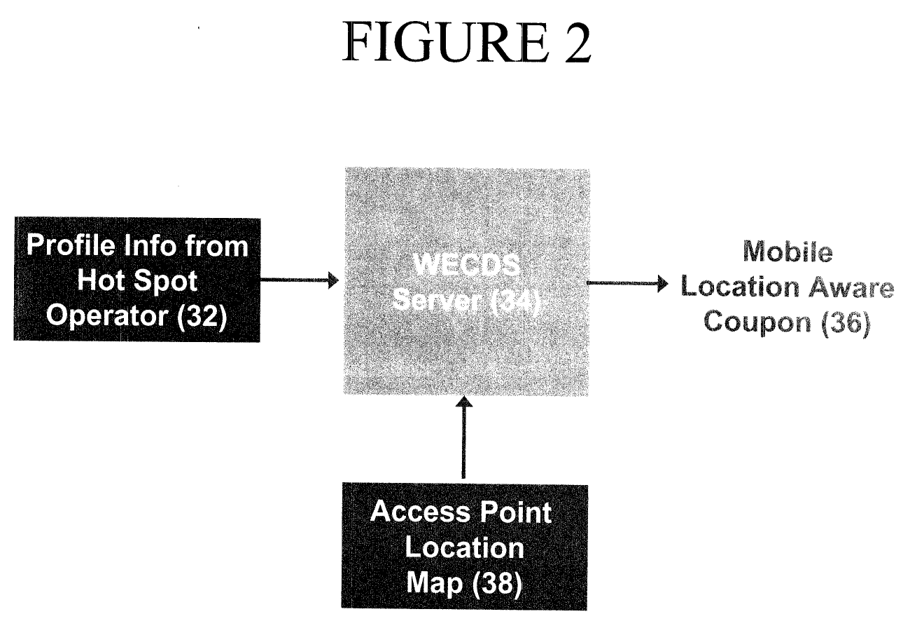

More specifically, referring to a preferred embodiment for the process of the invention, shown in FIGS. 1-2, a wireless LAN user at step 10 logs on to a wireless hotspot at step 20. Referring now to the “back-end” steps 30 shown in FIG. 2, user information collected by the hotspot operator through the hotspot registration process (e.g., name, address, telephone number, credit card information, employment, marital status, family information, etc., termed here “profile information”) at step 32 may be transmitted to the WECDS server at 34. The unique MAC address of the access point may be determined by linking the user's log-in name to his/her access point within the wireless network. (“MAC” is short for “media access control,” and refers to a hardware address that uniquely identifies each node of a network.) The WECDS system may now generate personalized or targeted mobile location aware coupons (MLACs) at step 36. The MLACs are personalized or targeted in the sense that profile information submitted during the hotspot registration process, for example, may be used to identify coupons the user may be interested in (e.g., users with pets may receive pet-related coupons, users with infants may receive infant-related coupons, etc.).

Personalized, targeted MLACs generated by the process steps illustrated in FIG. 2, for example, may now be transmitted at step 40 to the user. From a wireless computer, such as a laptop/notebook computer, PDA or interactive cell phone, for example, the user may now select or “click” on desired MLACs at step 45 of FIG. 1. These selected MLACs may then be transmitted to the WECDS website, which prompts the user of the wireless network to input his/her computer access code or cell phone number at step 60. The selected MLACs may have associated with them a unique coupon identifier code, which may be associated with the MLAC before or after it is selected by the user, and which may be transmitted to the user's wireless computer, such as an interactive cell phone, from the WECDS system by any expedient manner such as text messaging (e.g., SMS) technology, as per step 70 of FIG. 1. This allows the WECDS user to redeem the coupons he/she has selected in-store, at checkout for example, per step 80 of FIG. 1. In one non-limiting example, the user may advise checkout personnel of the coupon identifier code and/or a brief description of the coupon(s) selected, sufficient to allow the store to clear the coupon, which may then be entered into the electronic cash register, enabling use during checkout of the selected MLAC. Alternatively, the WECDS user may have printed the selected MLACs prior to entering the store, may print them in-store, or may receive them visually on a mobile computer such as a PDA or cell phone picture phone, and then physically hand the MLACs or verbally identify them to store personnel for clearing and scanning at checkout.

Other changes and modifications constituting insubstantial differences from the present invention, such as those expressed here or others left unexpressed but apparent to those of ordinary skill in the art, can be made without departing from the spirit and scope of the present invention and without diminishing its attendant advantages. It is, therefore, intended that such changes and modifications be covered by the following claims.

1. A process for delivering electronic coupons to a user of a wireless fidelity network, comprising the steps of:
registering the user on the wireless fidelity network, the user providing profile information to the wireless fidelity network during the registration process;
the user logging in to the wireless fidelity network using a mobile communication device, enabling the wireless fidelity network to associate the user with the profile information, and also enabling the network to locate the user using a MAC address of an access point associated with the user's mobile communication device;
using at least a portion of the profile information and the location of the user to identify targeted electronic coupons for the user, and transmitting one or more of the targeted electronic coupons to the user over the wireless network using a dynamically-assigned IP address;
the user selecting one or more of the targeted electronic coupons and transmitting this selection over the wireless network;
requesting the usere to input a code associated with the mobile communication device; and
transmitting information necessary to clear the user-selected electronic coupons to the mobile communication device associated with the inputted code.

2. The process for delivering electronic coupons of claim 1, wherein the code inputted by the user comprises a mobile telephone number and the mobile communication device comprises a mobile telephone.

3. The process for delivering electronic coupons of claim 1, wherein the code inputted by the user comprises an access code to a PDA and the mobile communication device comprises a PDA.

4. The process for delivering electronic coupons of claim 1, wherein the profile information comprises a user name and address.

5. The process for delivering electronic coupons of claim 1, wherein a server on the wireless network locates the user within the wireless network using a MAC address.

6. The process for delivering electronic coupons of claim 1, wherein the step of identifying targeted electronic coupons for the user is accomplished by a server on the wireless fidelity network.

7. The process for delivering electronic coupons of claim 1, wherein a server on the wireless fidelity network receives the selected, targeted electronic coupons from the user.

8. The process for delivering electronic coupons of claim 1, wherein a server on the wireless fidelity network requests the user to input the mobile telephone number, and transmits the information necessary to clear the user-selected electronic coupons to the mobile telephone associated with the mobile telephone number input by the user.

9. The process for delivering electronic coupons of claim 1, wherein the information transmitted corresponding to the user-selected electronic coupons is sufficient to enable a store to clear the coupon during a store checkout procedure involving goods or services associated with the coupon.

10. The process for delivering electronic coupons of claim 1, wherein the information necessary to clear the user-selected electronic coupons include a unique coupon identifier code.

11. A wireless fidelity network enabling the delivery of targeted electronic coupons, comprising:
one or more servers associated with the wireless fidelity network in communication with user-accessible computers enabling user registration, wherein users provide profile information to the computers during the registration process;
following user log-in to the wireless fidelity network, the wireless network associating a logged-in user with profile information for that user;
transmitting the MAC address of the access point associated with the logged-in user to the one or more servers, enabling the wireless network to locate the user within the wireless network;
the one or more servers using at least a portion of the profile information and the location of the MAC address of the associated access point to identify targeted electronic coupons to be transmitted to an associated user's computer, and transmitting one or more of the targeted electronic coupons to the computer of the associated user over the wireless network, enabling the user of the computer to select one or more of the targeted electronic coupons and to transmit this selection to the one or more servers over the wireless network; and
the one or more servers of the wireless network requesting the user to input a mobile telephone number and then, upon receipt of the mobile telephone number, transmitting information necessary to clear the user-selected electronic coupons to a mobile telephone associated with the mobile telephone number input by the user.

12. The wireless network of claim 11, wherein the computer comprises a PDA or mobile telephone.

13. The wireless fidelity network of claim 17, wherein the transmitted information associated with the selected electronic coupons comprises barcode information relating to the coupons which may be sent by short message or text messaging, stored on the mobile phone, and scanned by an electronic reader during the store checkout procedure.

14. A process for delivering electronic coupons to a user of a wireless fidelity network, comprising the steps of:
registering the user on the wireless fidelity network, the user providing profile information to the wireless fidelity network during the registration process;
the user logging in to the wireless fidelity network using a mobile communication device, enabling the wireless fidelity network to associate the user with the profile information, and also enabling the network to locate the user using a MAC address of an access point associated with the user's mobile communication device;
using at least a portion of the profile information and the location of the user to identify targeted electronic coupons for the user, and transmitting one or more of the targeted electronic coupons to the user over the wireless network using a dynamically-assigned IP address; and
the user selecting one or more of the targeted electronic coupons and transmitting this selection over the wireless network.

15. The process for delivering electronic coupons of claim 14, further comprising the steps of:
requesting the user to input a code associated with an in-store printer accessible to the user; and
transmitting the user-selected electronic coupons to the in-store printer.

16. The process for delivering electronic coupons of claim 14, further comprising the steps of:
requesting the user to input a code associated with an electronic cash register accessible to the user; and
transmitting the user-selected electronic coupons to the electronic cash register.

17. The process for delivering electronic coupons of claim 1, wherein the information transmitted corresponding to the user-selected electronic coupons is sufficient to enable a store to clear the coupon during a store checkout procedure involving goods or services associated with the coupon.
